(19) United States
(12) Patent Application Publication
(10) Pub. No.: US 2019/0336964 A1
(43) Pub. Date: Nov. 7, 2019

(54) Specimen Container with Locking Cap for Closed Container Sampling in Clinical Auto-Analyzers

(71) Applicant: Natalie Levy Sarraf, Santa Monica, CA (US)

(72) Inventor: Natalie Levy Sarraf, Santa Monica, CA (US)

(21) Appl. No.: 15/969,774

(22) Filed: May 3, 2018

(51) Int. Cl. B01L 3/00; G01N 35/02; G01N 35/10

(52) U.S. Cl. CPC B01L 3/508; G01N 35/02; B01L 2200/0689; B01L 2300/042; B01L 2300/044; G01N 35/1079

(57) ABSTRACT

A specimen container and cap for the same are constructed for one time capping of the container following specimen collection after which the cap is not removable to assure specimen purity and integrity. A self-resealing elastomeric septum on the cap admits passage of a sampling pipette into the container allowing the capped container to be processed in existing clinical analyzers with auto-pipetting stations currently processing open, uncapped specimen containers.

### BACKGROUND OF THE INVENTION

### Field of the Invention

This invention pertains to the field of clinical laboratory supplies and more specifically to specimen containers used to collect biological samples and deliver the same to clinical laboratory facilities for analysis.

### State of the Prior Art

Specimens of biological fluids such as urine are processed in automated analyzers having transport mechanisms for delivering a sequence of specimen containers to auto-pipetting stations adapted for advancing a sampling pipette, typically a small diameter metal tube, into each specimen container as it is presented by the transport mechanism and drawing a sample of the liquid specimen in the container for processing in the analyzer portion of the machine.

In current practice the specimen containers are normally open as they are carried along the transport mechanism to the pipetting station, where the open container top is positioned under the sampling pipette which dips briefly into the liquid specimen and aspirates a fraction of the specimen as a sample for analysis by the machine. The container with the remaining portion of the specimen is moved out of the pipetting station and closed, as by recapping, and may be placed in storage for possible future use.

This practice carries certain risks and shortcomings including possible spillage of specimen fluid as containers may be jostled on the transport mechanism, contamination of specimens from the environment, and cross-contamination between adjacent open containers as specimen fluid is drawn at the pipetting station.

### SUMMARY OF THE INVENTION

The present invention provides a specimen container which once capped following deposit of a specimen at a specimen collection location subsequently retains the container cap in a substantially non-removable manner. The capped specimen container travels to a laboratory location and remains capped as the container is penetrated by a sampling pipette for extracting an analytical sample of the specimen. The container may then be placed in storage for possible subsequent re-use. The container remains closed at all times following collection of the specimen to protect the specimen against loss and contamination, yet the specimen in the closed container can be accessed multiple times for extraction of further analytical samples if needed.

The capped specimen container is preferably configured for one-time specimen collection and multiple-time specimen sampling, and comprises a specimen container, a cap for making one-time non-releasable closure of an aperture in the specimen container, and a septum for admitting the blunt tip of a liquid transfer implement such as a sampling pipette into the container for withdrawing a sample of the specimen, the septum being substantially self-resealing following withdrawal of the pipette.

More particularly this invention may be summarized as a capped container for holding a liquid specimen to be processed in an analyzer of the type having a conveyor system for transporting a sequence of the capped containers to an automated pipetting station adapted for momentarily extending a sampling pipette into each capped container and drawing a sample of the specimen from the container for processing in the analyzer, wherein the capped container comprises a container having a container bottom and one or more container walls with a rim defining an opening into an interior of the container; a cap adapted to make liquid tight closure of the opening in an assembled condition with the capped container, the cap and the container having mutually interlocking portions configured for making non-releasable engagement with each other thereby to permanently fasten the cap to the container in an assembled condition, and an elastomeric septum in the cap penetrable by a sampling pipette of the aforesaid pipetting station.

A compressible seal may be provided between the cap and the container to enhance liquid tight closure of the aperture in the specimen container.

The elastomeric septum may be substantially self-resealing against leakage of liquid from the capped container following penetration by and withdrawal of the sampling pipette, and the elastomeric septum may be initially unperforated prior to penetration by the sampling pipette.

In one form of the invention the non-releasable fastening of the cap to the container occurs in snap-on fashion and the interlocking portions may be configured for providing tactile and/or audible feedback indicative of the non-releasable engagement therebetween.

The non-releasable fastening of the cap to the container preferably requires only pressing of the cap onto the container in a linear or axial direction, that is, without turning of the cap relative to said container.

### BRIEF DESCRIPTION OF THE DRAWINGS

FIG. 1 is a top side perspective view of a capped container according to this invention;

FIG. 2 is a vertical cross-section of the capped container taken along line 2-2 in FIG. 1 with a typical pipette shown inserted through the elastomeric seal in the cap and into the container;

FIG. 3 is a cross-sectional view as in FIG. 2 with the showing the cap and container apart prior to capping of the container;

FIG. 4 is a top plan view of the container cap; and

FIG. 5 is a bottom plan view of the cap of FIG. 4.

### DETAILED DESCRIPTION OF THE PREFERRED EMBODIMENT

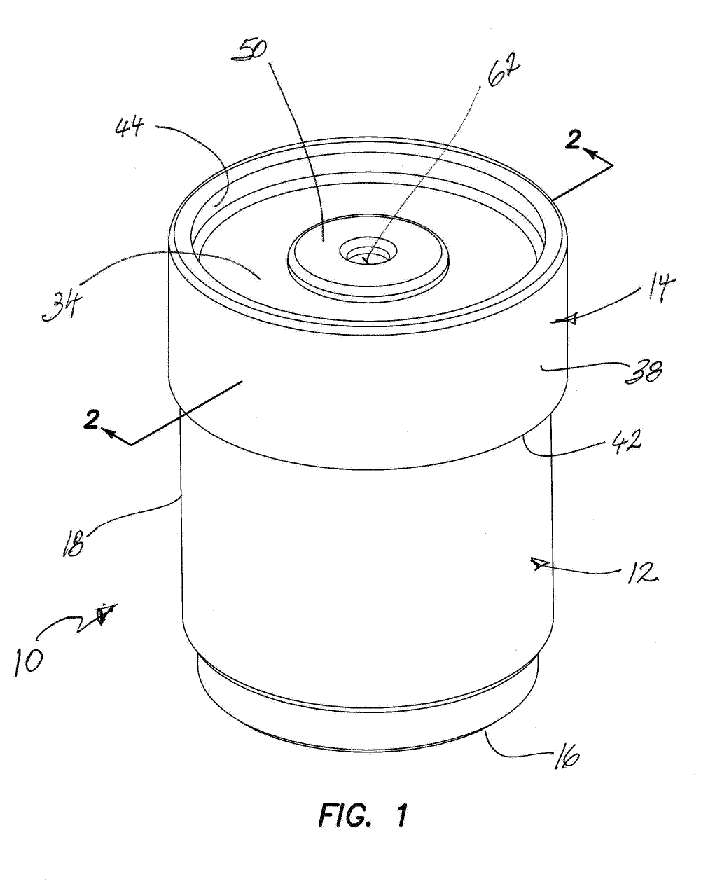

With reference to the accompanying drawings wherein like elements are designated by like numerals, FIG. 1 illustrates a capped specimen container according to this invention, generally designated by numeral 10.

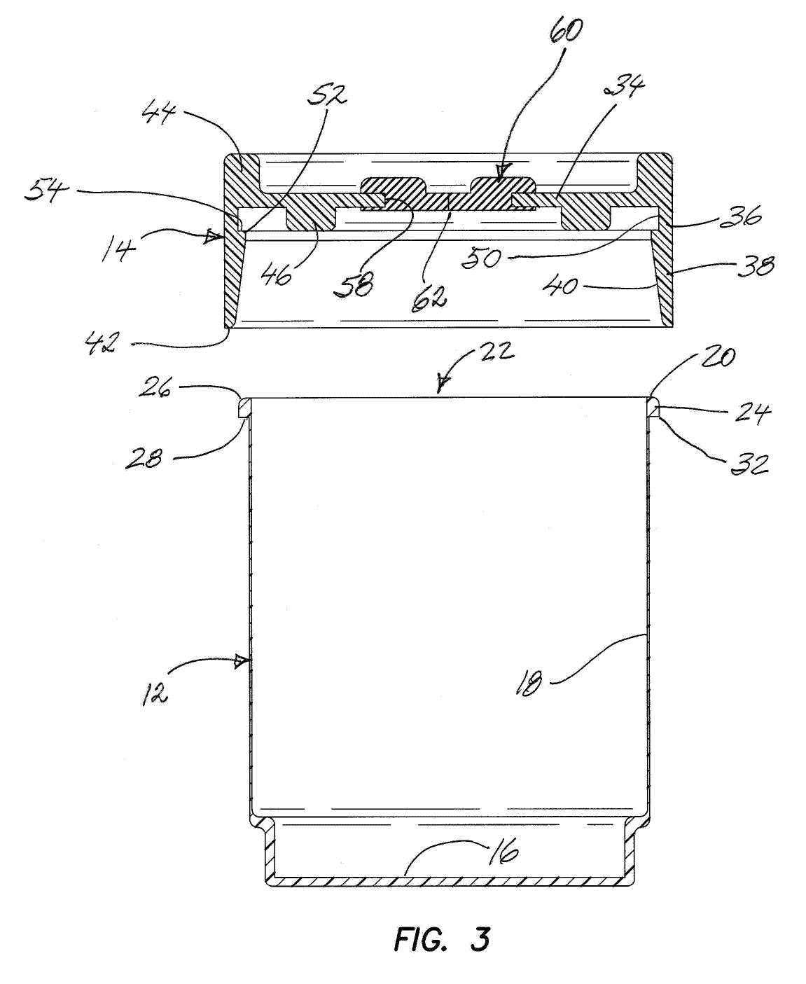

The capped container 10 includes a container 12 and a container cap 14 as best understood from FIG. 3 where these two parts are shown in separated relationship. Container 12 of the illustrated embodiment is cylindrical with a container bottom 16 and a container wall 18 terminating in an upper rim 20 which defines an open upper end 22 of container 12. A radial bead 24 encompasses the open upper end 22 at rim 20. Seen in radial cross section bead 24 has a rounded upper shoulder 26 and a bead undersurface 28 which is substantially square to the vertical axis of container 12 and includes a relatively sharp bead edge 32.

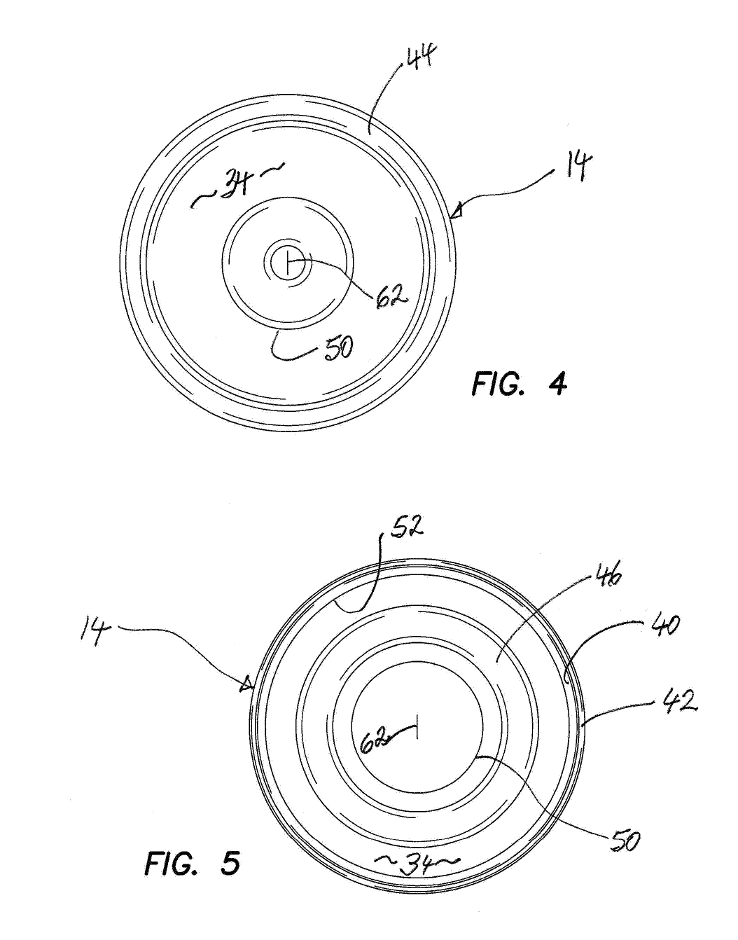

Cap 14 includes a cap top 34 supported within an annular cap wall 36. The cap wall 36 has a cap skirt 38 dependent beneath cap top 34. Skirt 38 terminates in a circular lower edge 42 sized to admit upper rim 20 of container 12. Cap 14 further has annular reinforcing ribs including upper rib 44 and lower rib 46, as shown in top and bottom views in FIGS. 4 and 5, respectively.

Skirt 28 has an interior ramp surface 40 which extends from rounded lower edge 42 to terminate at its upper end at a radial groove 50 of enlarged diameter located under cap top 34. The diameter of ramp surface 40 transitions abruptly at edge 52 and radial shoulder 54 to the larger diameter of groove 50.

The cap 14 is assembled to container 12 by first seating ramp surface 40 onto the rounded shoulder 26 of rim bead 24 to cover the open upper end 22 of the container, and then applying downward force onto cap top 34, pressing cap 14 onto container 12 with sufficient force for rounded shoulder 26 and bead 24 to ride up along ramp surface 40 until bead undersurface 32 rises above edge 52 and expands radially onto shoulder 54 and into groove 50.

The outside diameter of rim bead 24 is smaller than the maximum inside diameter of ramp surface 40 at its lower edge 42 and slightly larger than the minimum inside diameter of the ramp surface 40 at its upper end at edge 52. The relative dimensions are such that rounded shoulder 26 first makes contact at an elevational midpoint of ramp surface 40 above lower edge 42 when the cap is first seated onto bead 24.

The cap 14 and container 12 are made as by molding of relatively stiff but sufficiently elastomeric material to allow for expansion of skirt 38 and/or compression of bead 24 for enabling bead 24 to ride up the diminishing inside diameter of radial ramp surface 40 until bead 24 enters groove 50, followed by elastic expansion of the bead into the groove and thereby capturing the bead in the groove.

The combination of materials and geometry of cap 14 and container 12 is such that downward manual pressure on cap 14 is sufficient to force bead 24 into groove 50 but once assembled the cap cannot separated and removed from the closed container by any reasonable manual effort. The geometry of the square shoulders 28, 54 and relatively sharp edges 32, 52 of the bead and groove, respectively, operate as mutually interlocking elements to retain and lock together the assembled cap and container against subsequent separation.

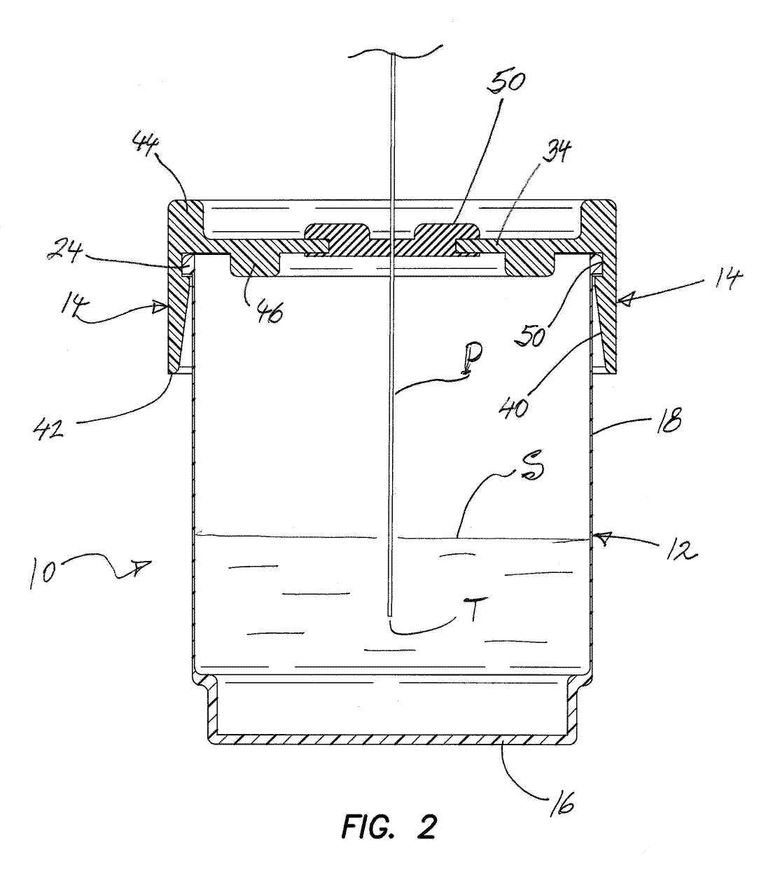

The materials are chosen and dimensioned so that ordinary manual force is sufficient to accomplish this assembly, as by placing container 12 on a convenient supporting surface such as a table or counter, placing the cap over the open top of the container and pressing down on the cap 14 with the palm of one hand until the above described retentive engagement occurs between cap 14 and container 12. The retentive engagement is permanent and irreversible. In other words, once the cap 14 is assembled to container 12 as illustrated in FIG. 2 the cap cannot thereafter be removed to open the container. Only linear, compressive force along the axis of cylindrical container 12 is needed in this operation, without any turning or rotation of the cap relative to the container as might be needed in the case of a threaded cap closure which is normally a two handed operation.

In some embodiments of the invention a ring seal of soft compressible materials such as a silicone may be provided between the cap 14 and container 12 to enhance the liquid-tight seal between these two elements.

Cap 14 carries an elastomeric septum 60 molded in place within a cap hole 58. The septum 50 is constructed for admitting passage of a liquid transfer implement, such as the metal pipette of an automated clinical analyzer or the tip of a plastic laboratory pipette, and is self-resealing following withdrawal of the implement. The septum 50 may be pre-cut with a small slit 62 to facilitate passage of the liquid transfer implement, as shown in FIGS. 4 and 5, or preferably may be initially closed but constructed to permit perforation with the blunt tip of such an implement. An initially unperforated septum may be preferable in applications where the specimen is to be transported by air due to possible loss of specimen material caused by air pressure differentials in flight.

FIG. 2 depicts a typical pipette P of an auto-analyzer (not shown in the drawings) in the form of a small diameter metal tube with a blunt tip T inserted through septum 50 and into a liquid specimen S contained in the capped specimen container 10. An analytical sample fraction of the liquid specimen S may be aspirated through pipette tube P for processing in the analyzer.

It is contemplated that the specimen container 10 with locking cap 14 according to this invention may be substituted for specimen containers in current use without modification to the mechanisms of analyzers presently available. The locked capped container 10 of this invention may be used for delivery of clinical specimens to auto-analyzers of conventional design, such as those equipped with a transport system for supplying a sequence of specimen containers to an auto-pipetting station designed to momentarily introduce a pipette into each such specimen container for drawing therefrom an analytical sample. The conventional auto-pipetting station is typically configured for receiving a specimen container under a pipette tube which is automatically advanced or lowered by the analyzer machine into the container and into a volume of specimen liquid in the container, from which an analytical sample is drawn up through the pipette and into the analyzer. The pipette is then automatically retracted by the machine and the pipette tip is withdrawn from the capped container. The elastomeric septum 50 is then free to self-reseal as by elastically bringing together the edges of slit 56 or to close an opening first made by the tip of the pipette, closing the septum against subsequent loss of specimen liquid S or entry of contaminants into the capped container 10. The transport mechanism of the automated analyzer machine may then move the capped container 10 out of the auto-pipetting station for removal and disposal or possible storage. The closed container 10 with specimen S may be stored and subsequently analytical samples drawn multiple times without ever removing cap 14 to open container 12. The specimen S remains covered and protected against possible spillage or contamination at all times following its initial collection and capping, including through multiple analytical sample draws from the specimen S as well as any intervening transport and storage.

From the foregoing it will be understood that the capped container 10 may be capped and permanently closed immediately following collection of a liquid specimen after which it cannot be reopened in a non-evident manner, and remains closed thereafter through any transport of the container 10 from a specimen collection location to an analysis location. For example, a patient in a doctor's office may deposit a liquid specimen such as urine into open container 12 and then close the container by pressing down on a cap 14 which locks to container 12 as previously explained. The closed container 10 with the specimen can be taken or shipped to a clinical laboratory, which might be at a distant location, for clinical analysis in a conventional auto analyzer machine. By appropriate selection of materials and configuration of the capped container 10, no modification may be needed to existing commercially available auto analyzers and auto-pipetters to permit use of specimen containers according to this invention in such equipment.

While the foregoing description refers to clinical laboratory applications of this invention it should be understood that the capped container 10 disclosed here may find useful application in many other fields where protection and preservation of liquid specimens against loss or contamination is needed.

While a particular presently preferred embodiment of the invention has been described and illustrated for purposes of clarity and example, many changes, modifications and substitutions will be apparent to those having only ordinary skill in the art without departing from the scope of the invention as defined by the following claims.

What is claimed is:

1. A specimen container with locking cap for holding a liquid specimen to be processed in an analyzer of the type having a conveyor system for transporting a sequence of specimen containers to an automated pipetting station adapted for momentarily extending a sampling pipette into each specimen container and drawing a sample of a specimen in the container for processing in the analyzer, comprising:
a container having a container bottom and one or more container walls with a rim defining an opening into an interior of said container, a cap adapted to make liquid tight closure of said opening in an assembled condition with said container, said cap and said container having mutually interlocking portions configured for non-releasably fastening said cap to said container in said assembled condition and for making liquid tight closure upon interlocking engagement with each other, and an elastomeric septum in said cap penetrable by a said sampling pipette of a said pipetting station.

2. The specimen container of claim 1 wherein said elastomeric septum is substantially self-resealing against leakage of liquid from said container following penetration by and withdrawal of a said sampling pipette.

3. The specimen container of claim 2 wherein said elastomeric septum is initially unperforated prior to penetration by a said sampling pipette.

4. The specimen container of claim 1 wherein said non-releasable fastening of said cap to said container occurs in snap-on fashion.

5. The specimen container of claim 1 wherein said non-releasable fastening of said cap to said container requires only pressing of said cap onto said container.

6. The specimen container of claim 1 wherein said interlocking portions are configured for providing tactile feedback indicative of said non-releasable engagement.

7. The specimen container of claim 1 wherein said interlocking portions are configured for providing audible feedback indicative of said non-releasable engagement.

8. The specimen container of claim 1 wherein said non-releasable engagement is made without turning of said cap relative to said container.

9. The specimen container of claim 1 further comprising a compressible seal between said cap and said container.

10. A specimen container comprising:
a container defining an aperture therein for receiving a liquid specimen;
a cap configured for making one-time non-releasable liquid-tight closure of said aperture; and
an elastomeric septum in said cap penetrable by the tip of a sampling pipette for withdrawing a sample of said specimen, said septum being substantially self-resealing following withdrawal of said pipette.

11. A method of delivering clinical specimens for clinical analysis in an auto-analyzer machine of the type having a conveyor system for transporting a sequence of specimen containers to an automated pipetting station adapted for momentarily extending a sampling pipette into each specimen container and drawing a sample of a specimen in the container for processing in the analyzer, comprising the steps of:
providing a container defining an aperture therein for receiving a liquid specimen and a cap configured for making one-time non-releasable liquid-tight closure of said aperture, and an elastomeric septum in said cap penetrable by the tip of a sampling pipette for withdrawing a sample of said specimen, said septum being substantially self-resealing following withdrawal of said pipette;
depositing a specimen in said container at a specimen collection location;
closing said container at said specimen collection location by pressing said cap onto said container to make permanent closing retentive engagement of said cap with said container;
conveying the closed specimen container to an analysis location;
introducing the closed container into an auto analyzer such that the closed container is presented to an auto pipetting station of said auto analyzer and a pipette of said auto pipetting station is introduced through said septum for sampling of the specimen in said container and then withdrawn from said container,
allowing said septum to substantially self-reseal; and
removing said closed container from said auto-analyzer.
